(19) United States
(12) Patent Application Publication
(10) Pub. No.: US 2009/0277472 A1
(43) Pub. Date: Nov. 12, 2009

(54) Photoresist Stripping Method and Apparatus

(75) Inventors: Michael Rivkin, Los Altos, CA (US); Peter Krotov, San Jose, CA (US)

Correspondence Address: Weaver Austin Villeneuve & Sampson LLP - NOVL;Attn.: Novellus Systems, Inc., P.O. Box 70250, Oakland, CA, 94612-0250, US

(73) Assignee: NOVELLUS SYSTEMS, INC., San Jose, CA (US)

(21) Appl. No.: 12/435,890

(22) Filed: May 5, 2009

Related U.S. Application Data
(60) Provisional application No. 61/050,880, filed on May 6, 2008.

(51) Int. Cl. C25F 3/30; B08B 3/02; B08B 3/10; B08B 3/08

(52) U.S. Cl. 134/1.3; 134/56 R; 134/105; 134/102.2

(57) ABSTRACT

The present invention pertains to methods for removing unwanted material from a work piece. More specifically, the invention pertains to stripping photoresist material from, e.g., a semiconductor wafer during semiconductor manufacturing. Methods involve implementing a pedestal for supporting a wafer, which pedestal has a low emissivity surface to reduce heat transfer by radiation.

### CROSS-REFERENCE TO RELATED APPLICATIONS

This application claims benefit under 35 U.S.C. §119(e) to U.S. Provisional Application No. 61/050,880, filed May 6, 2008, which is incorporated by reference herein.

### TECHNICAL FIELD

The present invention relates generally to methods and systems for stripping photoresist and removing residues from the surface of a substrate comprising a partially fabricated integrated circuit in preparation for further processing and more particularly to methods and apparatus that make use of pedestals having adjustable positions relative to substrates.

### BACKGROUND

The photoresist is a light-sensitive organic polymer, which can be “spun on” in liquid form and dried or cured to form a solid thin film. Thereafter, the photoresist, which is photosensitive, is patterned using light passed through a mask followed by exposure to a wet solvent. In some IC fabrication steps, a plasma etching process (dry etch) is then used to etch the exposed portions of substrate and transfer the pattern to the substrate. This pattern may represent, for example, trenches, vias, and other features of the IC, which are formed in silicon, metal, or dielectric layers. In other fabrication steps, a high energy dopant ion implantation is performed on the photoresist patterned substrate to define doped and undoped regions on the substrate. These steps may produce a cross-linked “crust” or skin on the top surface of the photoresist.

Once the substrate is etched and/or doped, the photoresist must be stripped and any residues must be thoroughly removed before subsequent processing to avoid embedding impurities in the device. Conventional processes for stripping the photoresist employ plasma formed from a mixture of gases with the presence of oxygen in the plasma. The highly reactive oxygen based plasma reacts with and oxidizes the organic photoresist to form volatile components that are carried away from the wafer surface.

Current stripping reactors employ one or more stations in a plasma chamber. Each station has a pedestal for holding the substrate while it is processed at the station. In multi-station chambers, the substrate is heated and exposed to plasma in a succession of stations, moving from one to the next automatically under the control of a robot. Stripping chambers may also include one or more plasma sources, each providing, e.g., energy for generating plasma and optionally a plasma showerhead for distributing gas/plasma toward a substrate on the pedestal. In multi-station chambers, it is common to have multiple plasma sources. In some cases each station has its own plasma source.

Temperature control is an important feature of any stripping tool. Often the stripping process has a particular thermal budget, which defines the total amount of thermal energy that should be applied to the substrate during the entire stripping process. The thermal budget limits the time and temperature of the stripping process. Further, excessive temperatures or very rapid increases in temperature can be problematic.

One problem of particular concern is crust “popping” on the photoresist during rapid temperature increases. As mentioned, a crust typically forms on photoresists that have been exposed to an ion implantation operation. If such photoresists are exposed to rapid temperature excursion during stripping, the crust may pop causing incomplete photoresist removal and particle contamination.

The goal of many commercial stripping tools is to strip wafers having photoresists with crusts as well as wafers having photoresists without crusts. The tools should be able to do this while maintaining high throughput and the same temperature set points of the pedestals. Wafers having photoresists without crusts require pedestals with a relatively high temperature, e.g., in the vicinity of 350-450° C., to achieve adequate stripping. Unfortunately, if wafers having photoresists with crusts are treated at the same temperatures, they can become overheated and possibly pop before the crust is fully removed. One possible approach to addressing this issue is to lower the pedestals at early stations in a multi-station chamber when a relatively low temperature is required and to raise pedestals in later stations where wafers are processed after crust removal. However, when this approach is used with anodized platens, which are generally used in the current stripping tools, it results in significant variability of wafer heating when a pedestal is lowered. Different substrate types can have substantially different rates of IR radiation absorption, which impact heat transfer particularly when the pedestal is lowered. Further, each type of wafer has its own temperature profile for optimal stripping performance due to different levels and depths of ion implantation. Finally, within the group of wafers having photoresists with crusts, some wafers may have high absorption of infrared radiation (e.g., highly doped wafers with low resistivity) and others lower absorption of infrared radiation (e.g., high resistivity wafers). As a result, when those wafers are moved through a tool with high emissivity pedestals, such as anodized pedestals, they absorb thermal energy vastly differently resulting in a wide wafer temperature distribution when photoresist ashing takes place. The tool needs to be able to treat each of these various wafers effectively.

If a process is optimized for high resistivity wafers, low resistivity wafers can heat up too fast giving rise to a higher risk of crust popping. On the other hand, if a process is optimized for low resistivity wafers, then high resistivity wafers are heated too slowly and their crust, which is insufficiently removed in early stages, may pop at later stages of the multistage tool where rapid heating occurs. Typically, a stripping tool runs high and low resistivity wafers with same recipe, which is at the edge of crust popping for low resistivity wafers. Such recipe barely heats the high resistivity wafers and can makes crust removal on those wafers very slow.

What is needed therefore is improved and methods and apparatus for stripping photoresist and controlling the temperature of the stripping process to afford flexibility in effectively stripping different types of wafers.

### SUMMARY

An example of an apparatus for stripping photoresist is described. The methods and apparatus of the invention may be used to remove photoresist/etch byproduct materials from partially fabricated integrated circuits. The apparatus employs certain features to control the temperature of wafers during stripping. Among these features are a low emissivity pedestal and pedestals that can be moved to different positions with respect substrates during heating and/or stripping operations. Certain embodiments of the stripping chambers include multiple stations, each with its own pedestal. Partially fabricated integrated circuits are moved from station to station during processing in such chambers.

In certain embodiments, a stripping tool includes a chamber which contains (i) a low emissivity pedestal for holding a substrate and (ii) a plasma source. The chamber is coupled to a vacuum pump for maintaining a low pressure during a stripping operation. The process chamber used in accordance with the methods and apparatuses of the invention may be any suitable chamber. The process chamber may be one chamber of a multi-chambered apparatus or it may be part of a single chamber apparatus. As indicated, in certain embodiments, the process chamber may include multiple stations, each with its own pedestal.

The pedestal includes a pedestal shaft and a platen, which supports the substrate during stripping, or least some of the stripping operation. In certain embodiments, the pedestal can move up and down with respect to the substrate and/or the chamber, for example, between raised and lowered positions. The pedestal platen has a heating element for controlling the temperature of the platen. In addition, the platen has a wafer-facing surface with a low emissivity, typically below about 0.5, and in certain embodiments between about 0.01 and 0.3, and certain specific embodiments between about 0.1 and 0.2.

In some cases, the process chamber may have pegs mounted in the chamber or fingers of the internal wafer transfer robot, which hold the wafer in place when the platen is lowered, at which times the wafer is not in contact with the platen face. However, at other times, when the platen is raised the wafer is supported by the platen itself In the raised configuration, the platen heats the wafer primarily by conduction. When using the low emissivity pedestals of this invention, wafer heating by radiation from the platen surface is minimal. So, when the pedestal is lowered, the pedestal provides very little heating of the wafer.

In some embodiments, the platen surface has small balls or other protrusions which support the wafer when the platen is raised to engage the wafer. When the platen contains such protrusions, and the wafer is supported by them, an average gap between the wafer and the platen surface may be, for example, between about 0 and 0.01 inches.

In multi-station chambers, an in-chamber robot moves wafers from one station to the next. Typically, though not necessarily, this is done when the pedestal is lowered so that the pedestal does not interfere with the robot's engagement of the wafer. Thus, while the wafer is supported by, e.g., pegs or fingers, the robot moves into position under the wafer and lifts the wafer out of position in the current station and moves it to the next station, where it lowers it onto the pegs or fingers associated with that station. A further, and potentially different, stripping process then takes place at the next station.

In order to provide low emission of radiation (e.g., infrared radiation) from a pedestal, the platen's surface finish may be chosen to have a low emissivity. Further, the surface finish may resist conversion to a higher emissivity state in the presence of the stripping plasma. In certain embodiments, this surface finish is limited to the surface facing the wafer. Lower emissivity of platens minimizes the effects of wafer resistivity on the heat transfer and improve temperature control for many substrate types within a narrow range. This helps to increase process throughput, particularly in stripping photoresists with crusts. For example, a typical semiconductor grade production yields substrates with different IR absorption rates. As explained above, this variability may be due to variable dopant concentrations in silicon (and hence resistivity of the wafer). Low emissivity platens can be used at higher temperature for all types of substrates, where highly emissive anodized platen radiation would be prohibitive because of heating rate differences between high and low resistivity silicon wafers.

As mentioned, low resistivity wafers heat up faster (and therefore ash faster) than the high resistivity wafers, but have higher risk of crust popping. A typical stripping recipe suitable for different types of substrates uses a lower temperature at early stages and provides only low heat transfer to the high resistivity wafers, thereby making crust removal on those wafers very slow. By reducing emissivity of platens, one reduces wafer resistivity dependence and higher platen temperatures may be used. Further, it allows better temperature control of any wafer within a narrower window, thus increasing, e.g., HDIS (High Dose Implant Strip) process throughput.

Various low emissivity materials may be employed for the platen surface. Examples of suitable metals include aluminum, rhodium, nickel, and gold. Various others will occur to those of skill in the art. The chosen material will have a low surface roughness to ensure suitably low emissivity. For example, for aluminum a surface roughness of between about 16 microinches and 32 microinches is suitable for many applications. Generally, a polished surface is suitable for this invention. However, there may be applications where a polished surface is not desirable as it can be scratched easily leading to increases in emissivity. One example of the material used on the platen surface is a bare aluminum alloy (e.g., Alloy 6061 from Alcoa) with a surface finish on the order of about 16 microinches as machined. A “jitterbug” finish can also be used; however such finish will result in higher emissivity. In order to reduce environmental effects from oxidizing plasmas, various coatings, such as nickel electroplating, can be used.

These and other features and advantages of the present invention will be described in more detail below with reference to the associated drawings.

### BRIEF DESCRIPTION OF THE DRAWINGS

FIGS. 1A and 1B are a schematic illustration showing an apparatus according to one embodiment of the claimed invention and suitable for practicing the methods of the claimed invention.

FIG. 2 is a schematic illustration of a multi-station stripping apparatus in accordance with certain stripping processes of this invention.

FIG. 3 is a schematic illustration of a multi-chamber stripping apparatus that may be used in accordance with certain stripping processes of this invention.

FIGS. 4A-4C are perspective illustrations of various features of a pedestal design in accordance with an embodiment of this invention.

FIGS. 4D and 4E show a bolt and retainer assembly that may be used to affix a flange to a platen in a pedestal intended for high temperature operation.

FIG. 4F illustrates a retainer used on a pedestal intended for high temperature operation.

FIGS. 5A and 5B are perspective drawings of a lift mechanism for coupling to a pedestal shaft and thereby allowing the pedestal to be raised and lowered between raised and lowered positions in a photoresist strip chamber.

FIG. 6 is a process flowchart of one method for stripping photoresist from a plurality of substrates having varying resistivity and/or photoresist conditions.

### DETAILED DESCRIPTION

### Introduction and Overview

In the following detailed description of the present invention, numerous specific embodiments are set forth in order to provide a thorough understanding of the invention. However, as will be apparent to those skilled in the art, the present invention may be practiced without these specific details or by using alternate elements or processes. In other instances well-known processes, procedures and components have not been described in detail so as not to unnecessarily obscure aspects of the present invention.

In this application, the terms “semiconductor wafer”, “wafer” and “partially fabricated integrated circuit” will be used interchangeably. Those skilled in the art will understand that the term “partially fabricated integrated circuit” can refer to a silicon wafer during any of many stages of integrated circuit fabrication thereon. The following detailed description assumes the invention is implemented on a wafer. However, the invention is not so limited. The work piece or substrate may be of various shapes, sizes, and materials. In addition to semiconductor wafers, other work pieces that may take advantage of this invention include various articles, such as printed circuit boards, displays, and the like.

Plasma stripping chambers in accordance with certain embodiments can be used in both “bulk” and HDIS strip processes. A bulk strip process removes photoresist, which has not been exposed to high dose ion implants and consequently does not have a significant crust. A HDIS process removes photoresist, which has been exposed to high does ion implants and, therefore, contains a substantial crust on top of the photoresist. A HDIS process employs a staged stripping process in which initial stripping conditions are optimized for removing crust to expose the bulk photoresist and subsequent stripping conditions are optimized differently for removing the bulk photoresist.

As an example, a bulk strip process heats the wafer to a temperature of, e.g., greater than about 250° C. (e.g., approximately 280° C.) very rapidly and thereafter ashing occurs at this temperature in the presence of an oxygen plasma. In contrast, an HDIS process begins by heating the wafer to a lower temperature, e.g., approximately 100-150° C., or more specifically 120-140° C. in certain embodiments, in the presence of an oxygen plasma until the crust is removed. Thereafter, the wafer may be rapidly heated to a higher temperature, e.g., greater than about 250° C., or more specifically about 280° C., where the plasma ashes the underlying exposed bulk photoresist.

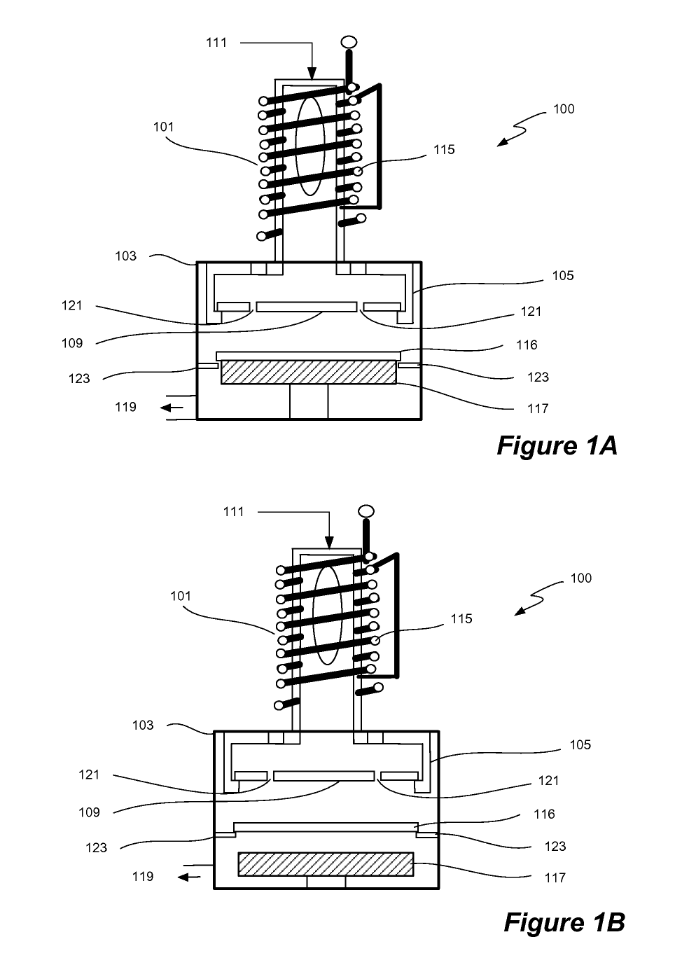

FIG. 1A is a simplified schematic illustration of an apparatus 100 with a platen 117 in a raised position. The apparatus 100 has a general collection of features that may be employed to some embodiments of the invention. The apparatus 100 has a plasma source 101 and a process chamber 103 separated by a showerhead assembly 105. The plasma source 101 is connected to a process gas inlet 111. A showerhead 109 forms the bottom of the showerhead assembly 105. Inside the process chamber 103, a wafer 116 with photoresist is supported by the platen (or stage) 117 when the platen 117 is in the raised position. The platen 117 may be fitted with a heating/cooling element and has a low emissivity surface facing the wafer 116. In some embodiments, the platen 117 is also configured for applying a bias to the wafer 116. Low pressure is attained in the process chamber 103 via the vacuum pump and conduit 119.

In operation, a process gas is introduced via the gas inlet 111 to the plasma source 101. The gas introduced to the plasma source 101 may contain the chemically active species and one or more forming species. The gas will be ionized in the plasma source to form a plasma. The gas inlet 111 may be of any type and may include multiple ports or jets. The plasma source 101 generates active species from the process gas to form a plasma. In FIG. 1A, the plasma source 101 is shown with RF induction coils 115. The coils 115 are energized to generate plasma. The showerhead 109 then directs the plasma into the process chamber 103 through the showerhead holes 121. There may be any number and arrangement of the showerhead holes 121 to maximize uniformity of the plasma/gas mixture and distribution towards the surface of the wafer 116. The showerhead assembly 105, which may have an applied voltage, may terminate the flow of some ions and allow the flow of neutral species into the process chamber 103.

The platen 117 is temperature controlled. The platen 117 transfers heat to the wafer 116 to achieve required process conditions for the photoresist removal from the exposed surface of the wafer 116. FIG. 1A shows the platen in a raised position where the platen 117 supports the wafer 116. The platen 117 contacts the wafer 116 at multiple points. There is a very little, if any, average gap between the platen 117 and the wafer 116 when the platen is in the lowered position. The average gap is determined by the presence and design of the supporting bumps, if any, on the wafer-facing surface of the platen 117 and the relative flatness of the wafer 116 and the wafer-facing surface of the platen 117. Because of the small gap and contact between the platen 117 and the wafer 116, most of the heat is transferred by thermal conduction.

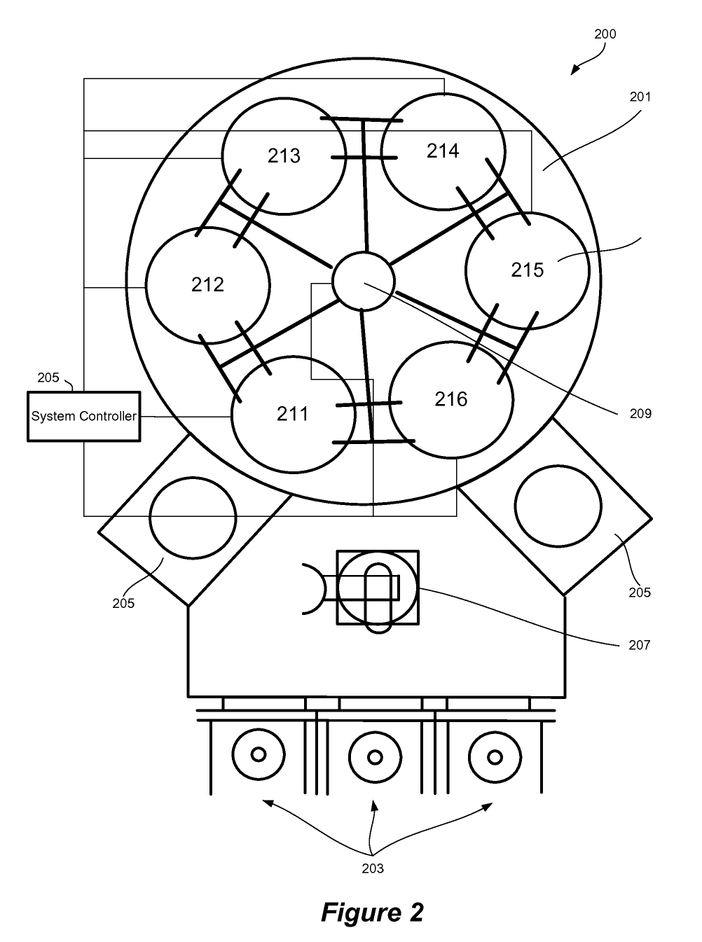

FIG. 1B illustrates the platen 117 in a lowered position. The wafer 116 is supported by pegs 123, which may be attached to the process chamber 103. In an alternative embodiment described in the context of FIG. 2, the wafer may be supported by fingers of the internal robot while the platen is in the lowered position. Lowering the platen 117 creates a substantial gap between the platen 117 and the wafer 116, which reduces the thermal conduction between the two. The reduction is particularly significant with larger gaps and lower operating pressures inside the process chamber 103. Further, the platen 117 has a low emissivity surface facing the wafer 116, which reduces and, in some instances, effectively eliminates radiative heat transfer from the platen 117 to the wafer 116. As a result, substantially less heat is transferred between the platen 117 and the wafer 116 when the platen 117 in the lowered position than when the platen 117 is in raised position allowing precise control the wafer temperature in a lower temperature region while the platen 117 is maintained at the same temperature. The gap between the platen 117 and the wafer 116 may be adjusted depending on the desired temperature region of the wafer 116.

The plasma is used to remove the photoresist (crust or bulk) from the wafer 116. The temperature of the wafer 116 determines the process regime, which may be adjusted depending on wafer types. For example, initial stations in the HDIS strip process may have their respective platens 117 in such positions as to ensure the temperature of the wafer is between about 120 and 140° C. while upper portions of the photoresist are removed in these stations. On the other hand, the bulk stripping process may use different platen positions. Further, a combination of platen positions and the timing at each station may be used to control temperature of the wafers during the entire process.

In some embodiments of the claimed invention, the apparatus does not include the showerhead assembly 105 and showerhead 109. In these embodiments, inert gas inlets introduce the inert gas directly into the process chamber 103 where it mixes with the plasma upstream of wafer 116.

FIG. 2 shows an example of a multi-station stripping apparatus 200. The apparatus 200 includes a process chamber 201 and one or more cassettes 203 (e.g., Front Opening Unified Ports) for holding wafers to be processed and wafers that have completed the strip process. The chamber 201 may have a number of stations, for example, two stations, three stations, four stations, five stations, six stations, seven stations, eight stations, ten stations, or any other number of stations. The number of stations in usually determined by a complexity of the processing operations and a number of these operations that can be performed in a shared environment. FIG. 2 illustrates the process chamber 201 that includes six stations, labeled 211 through 216. All stations in the multi-station apparatus 200 with a single process chamber 203 are exposed to the same pressure environment. However, each station may have individual local plasma and heating conditions achieved by a dedicated plasma generator and platen, such as the ones illustrated in FIGS. 1A and 1B.

A wafer to be processed is loaded from one of the cassettes 203 through a load-lock 205 into the station 211. An external robot 207 may be used to transfer the wafer from the cassette 203 and into the load-lock 205. In the depicted embodiment, there are two separate load locks 205. These are typically equipped with wafer transferring devices to move wafers from the load-lock 205 (once the pressure is equilibrated to a level corresponding to the internal environment of the process chamber 203) into the station 211 and from the station 216 back into the load-lock 205 for removal from the processing chamber 203. An internal robot 209 is used to transfer wafers among the processing stations 211-216 and support some of the wafers during the process as described below.

In a specific example, the station 211 is reserved for heating the wafer. The station 101 may have a heating lamp (not shown) positioned above the wafer and a platen supporting the wafer similar to one illustrated in FIGS. 1A and 1B. After the wafer is heated at the station 211, the wafer is moved successively to the processing stations 212, 213, 214, 215, and 216, which may or may not be arranged sequentially. In certain embodiments, the processing stations 212-215 (and possibly the station 216 as well) have pedestals with low emissivity platen surfaces, which are further described below.

Each processing station, e.g., stations 212, 213, 214, 215 and 216, may be provided with its own RF power supply (e.g., a downstream Inductively Coupled Plasma Radio Frequency source). Each station has a platen that may be adapted with a heating element and/or configured to applying a bias to a wafer. The multi-station apparatus 200 may have at least one station, preferably at least two stations, or even more stations that adapted with platen(s) residing in a lowered position to reduce heat transfer to a wafer.

For ease of understanding the invention, reference is made to three groups of processing stations. The station 211 is within Group A. The station 211 is typically configured with a load-lock 205 attached thereto for allowing the input of wafers from the cassettes 203 into the process chamber 201. The multi-station apparatus 200 is configured such that all stations are exposed to the same pressure environment. In so doing, the wafers are transferred from the station 211 to other stations in the process chamber 201 without a need for transfer ports, such as load-locks. The station 211 may also be configured with a heating lamp and/or a heated platen for pre-heating each wafer before it is transferred to the next processing station.

The internal robot 209 transfers wafers between stations 211-216 inside the processing chamber 201. Specifically, the internal robot is used to transfer wafers from the station 211 sequentially to the station 212 and then station 213. The stations 212 and 213 may be designated as the Group B processing stations. These Group B stations may include at least one station, preferably at least two or more stations, having a platen residing in the platen lowered position when removing an implant crust from a photoresist. Thus, there will be a gap between the wafers and the platens during the crust removal leading to lower temperatures of the wafer. During this operation, the platen may be heated, either resistively or with heating lamps. In some embodiments, the platen is maintained at a temperature set point (e.g., between about 350° C. and 450° C.).

While the Group B processing stations immediately follow the Group A stations in this embodiment, it should be appreciated and understood that the Group B processing stations may be positioned and implemented at any location inside the processing chamber 201. That is, the Group B processing stations may immediately follow the Group A stations, or they may be positioned at the beginning of the sequence of processing stations residing within the exposure chamber. In other embodiments, the Group B processing stations may be positioned at the end of such sequence of processing stations, or they may be intermittently spaced throughout the plurality of processing stations residing inside the exposure chamber, or even any combination thereof.

Wafers are transferred inside the processing chamber 201 via the internal robot 209. A spindle assembly may include a fin with at least one arm for each processing station, such that each arm extends toward one processing station. At the end of the arm adjacent to the processing stations are four fingers that extend from the arm with two fingers on each side. These fingers are used to lift, lower, and position a wafer within the processing stations. For example, in one embodiment, where the multi-station apparatus includes six processing stations, the spindle assembly is a six arm rotational assembly with six arms on one fin. For example, as shown in the drawings the fin of the spindle assembly includes six arms, with each arm having four fingers.

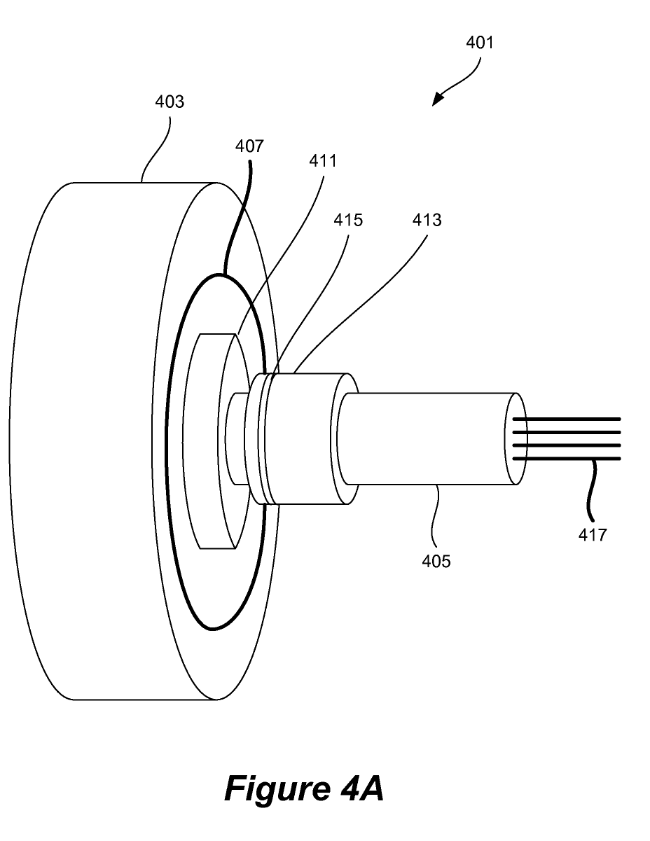

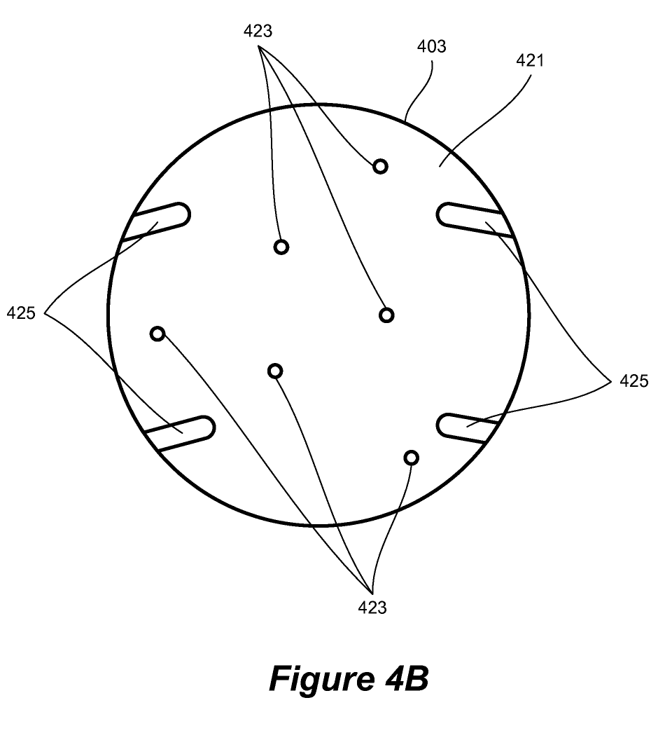

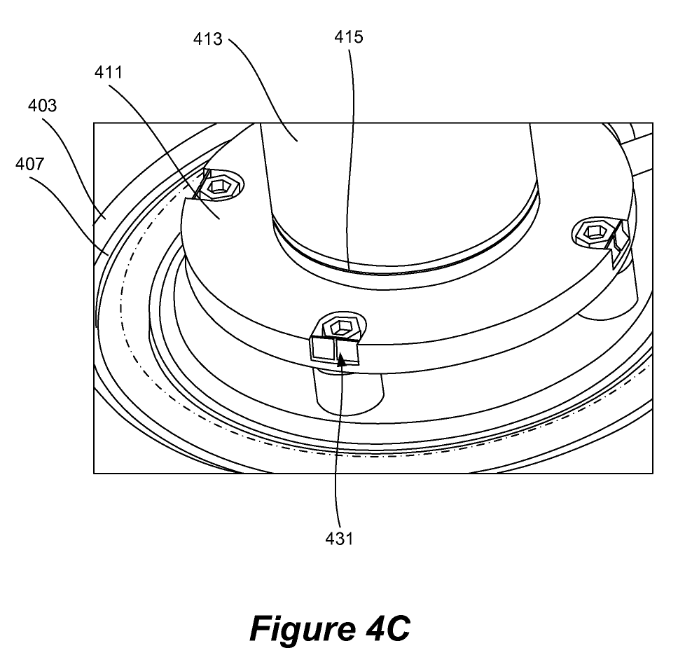

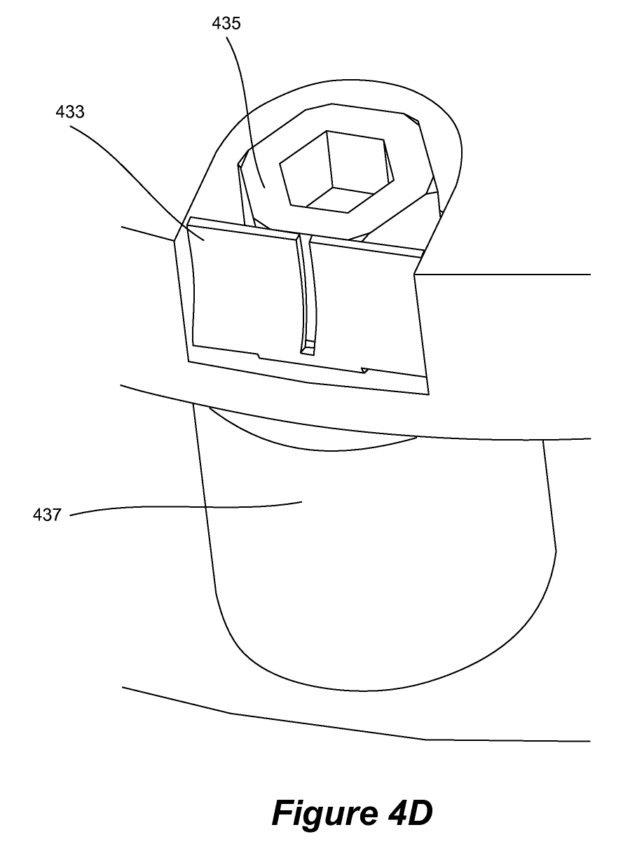

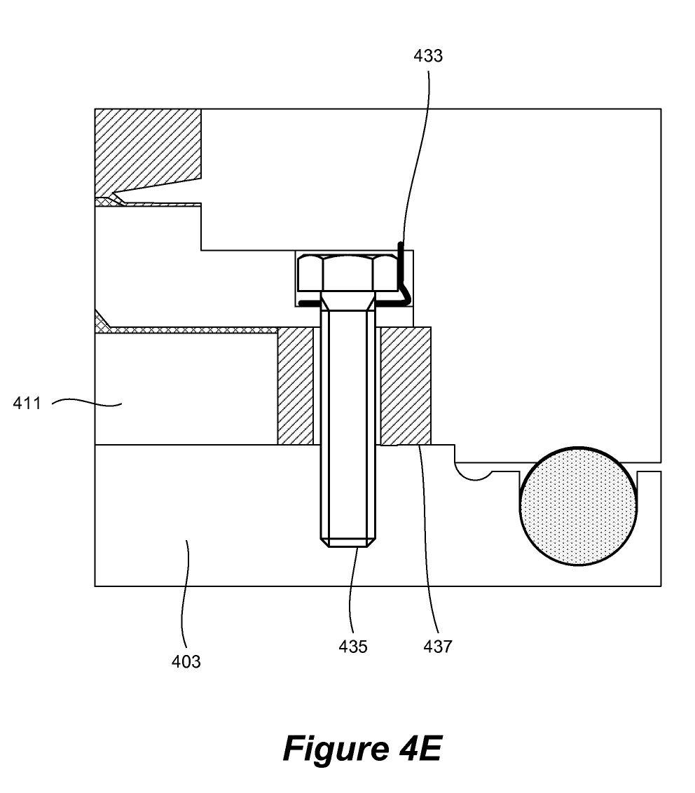

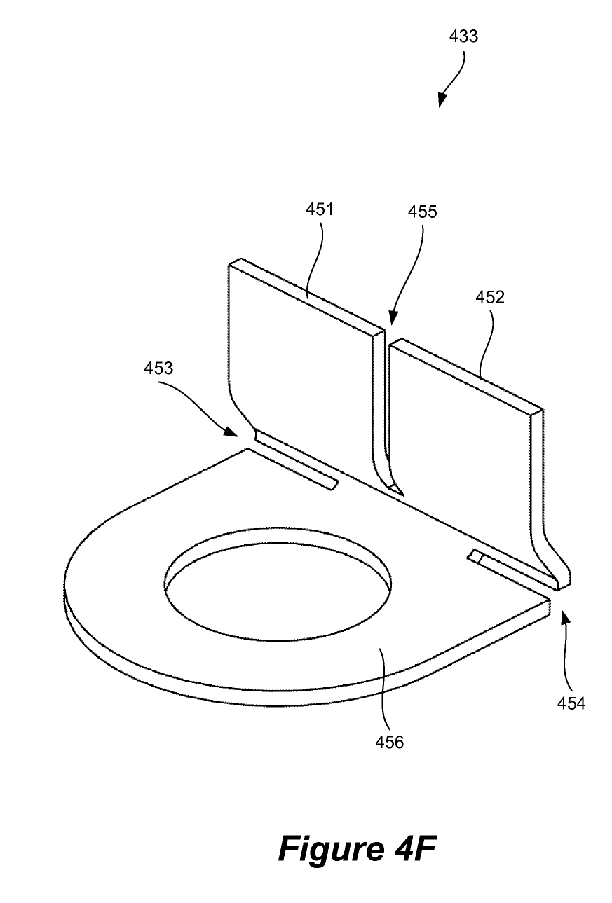

A set of four fingers, i.e., two fingers on a first arm and two fingers on an adjacent, second arm, are used to lift, position and lower a wafer from one station to another station. In this manner, the apparatus is provided with four fingers per platen, per station and per wafer. Each platen may include four openings for receiving the four fingers of adjacent arms as shown in FIG. 4B and described below.

Before a wafer is provided into the loading/pre-heating station 211, the spindle, fin, arms, and fingers are positioned such that the four fingers (two fingers on each of adjacent arms) reside within the openings of the platen that are adapted for receiving such fingers. In this manner, once a wafer having surfaces in need of stripping is loaded into the station 211, the wafer rests on and directly contacts both the four fingers of the arm as well as a top surface of the platen within station the 211.

The wafer is then pre-heated within the station 211 to a temperature that will affect the removal of any photoresist and unwanted material from the wafer surfaces. The wafer may be heated via heat transfer from a heated platen, which is itself heated either using an electrical heater or heating lamps. Alternatively or in combination with the heated platen, the wafer may be heated using heating lamps positioned above the station 211. Upon pre-heating the wafer, and during processing, the wafer preferably has a temperature ranging between about room temperature (e.g., about 25° C.) to about 300° C. The temperature is generally determined by the subsequent operation, such as crust stripping or bulk stripping.

Once the wafer is pre-heated, it may be transferred to the processing stations (e.g., stations 212 and 213) of Group B. The Group B stations each include a platen that can change its position between a lowered and raised position. Alternatively, the platen may permanently reside in the lowered position. In the raised position, the backside of the wafer may be in direct contact with a top surface of the platen or certain features on the surface of the platen, such as bumps. In the lowered position, the wafer avoids contact with the platen, including the backside of the wafer, resulting in a gap between the wafer and the platen.

In transferring wafer from the loading/pre-heating station 211, the internal robot 209 moves the arms of the fin in an upward direction within the process chamber 201, thereby lifting the wafer in an upward direction away from the platen of the station 211 via the four fingers residing under wafer. The spindle then moves the wafer from the station 211 to the processing station 212. As indicated, the platen in the processing station 212 may reside in the lowered position for HDIS processing, such that, when the four fingers carrying the wafer are received in the corresponding opening portions of this platen, the backside of the wafer only contacts a top surface of the four fingers. In so doing, a gap resides between the wafer and the platen such that the backside of wafer avoids contact with the platen in the processing station 212.

The platen may move between the raised and lowered positions within the station 102. In this manner, the opening portions of platen in the station 102 receive the four fingers carrying the wafer. The gap is created between the backside of wafer and the platen when the platen is in the lowered position, such that the backside of the wafer only contacts the fingers residing there under. The gap may be needed to reduce the heat transfer from the platen to the wafer during HDIS crust stripping operations, when it is desirable to keep the wafer at lower temperatures in comparison to bulk stripping. However, in order to maintain the wafer temperature and ensure a high strip rate, the platen may be moved into the raised position such that upon positioning the wafer within a processing chamber, the wafer contacts the platen for heating and maintaining a temperature of the wafer. This may be appropriate for a bulk strip process.

The wafer may then be transferred from the Group B processing stations to the Group C processing stations. In the Group C processing stations the backside of the wafer is provided in direct contact with the platens residing in these Group C stations. Any one, all, or a combination of the Group B and Group C pedestals may have a low emissivity surface in accordance with embodiments of this invention.

In transferring the wafer from the station 213 to the next processing station (e.g., station 214), fingers on adjacent arms lift the wafer away from station 213 and the spindle moves the wafer toward processing station 214. The fingers are received into the openings in the platen of station 214, and then the wafer is lowered directly onto such platen. The platens in stations 214, 215 and 216 may be stationary platens that remain in a raised position so that the wafer backside directly contacts the top surface of the platen. The plasma flows over station 104 to directly contact the front side of wafer for a period sufficient to strip off the remaining bulk photoresist in a HDIS or a bulk process.

In one example of a bulk strip process using a multi-station chamber, such as that depicted in FIG. 2, all of the pedestals remain up to contact the wafers during a high temperature stripping process. As indicated, it may be desirable to heat the wafer to a temperature of about 250° C. or greater (e.g., about 280° C.) for the bulk strip process. This may be accomplished by, for example, heating the pedestals to a temperature of about 350° C. to 450° C. (e.g., or between about 370° C. and 400° C.). If the processing chamber 201 has separate plasma sources for each of stations 212-216 or stations 212-215, the plasma sources may be all be turned on during the bulk strip process. Alternatively, the last two or three stations may have their plasma sources turned off (or intermittently turned off) during the bulk strip process.

An example of an HDIS strip process using a multi-station chamber, such as that described in FIG. 2, will now be described. When a wafer is positioned in the station 211, the associated pedestal is positioned in the raised position and the wafer is heated to a temperature of, e.g., between about 120° C. and 140° C. When the wafer is moved to the station 212 and then the station 213, the pedestals in each of these stations is placed in the lowered position so that it does not contact the wafer and further heating of the wafer is minimized. Alternatively, depending on the temperature profiles of the wafers, one or both of the pedestals in the stations 212 and 213 may be raised during some or all of the processing. This may be appropriate particularly when the apparatus encounters high resistivity wafers that are less susceptible to heating by absorption of radiation. Regardless, the substrate temperature in the stations 212 and 213 should hold at approximately the same temperature as in station 211 (e.g., between about 120° C. and 140° C.). In this example, crust removal may be performed in the stations 212 and 213.

When the substrate is moved the station 214, bulk stripping of the photoresist begins. Thus, the substrate temperature is increased (e.g., to about 250° C. or greater, e.g., to about 280° C.) by moving the pedestal of the station 214 into the raised position. In the raised position, the wafer-facing surface of the platen comes in the contacts with the wafer and provides additional heat transfer to the wafer primarily by thermal conduction. Further stripping occurs in the station 215. There the pedestal may be in either the raised or lowered position as appropriate for the thermal budget (or maximum temperature) specified for the overall stripping process. Typically, the substrate is maintained at a set temperature in each of the stations 214 through 216 (e.g., about 280° C. or about 285° C.). This may be accomplished by positioning the pedestals as appropriate in the stations 215 and 216. Generally, though not necessarily, the temperature of each pedestal in the stations 212-215 may remain at the same set point (e.g., between about 350° C. and 400° C.) regardless of which type of substrate is being processed (bulk or HDIS; low or high resistivity). In some modes of operation, the temperature of the substrate is controlled for each type of substrate by simply varying the position of the pedestals at individual stations, rather than adjusting the set point temperatures of the pedestals.

In many embodiments, the position of the pedestal varies between only one raised position and one lowered position. In other embodiments, which may afford more flexibility in temperature control, the pedestal may have other positions (with respect to the substrate being processed), and in some cases, the pedestal position may be continuously variable.

Generally, a gap between a substrate and a wafer-facing surface of the platen when the pedestal is in the lowered position may be between about 0.001 inches and 3 inches. More specifically, the gap may be between about 1 inch and 3 inches, or even more specifically between about 1.5 inches and 2.5 inches. The gap may be selected and/or adjusted during processing based on one or more factors, such as emissivity of a wafer-facing surface of the platen, temperature of the platen, initial temperature of the wafer when it is transferred to the station, wafer temperature requirements during the operation, thermal budget of the wafer, resistivity of the wafer, type of the photoresist on the substrate, and other process parameters. A lowered position of the pedestal is generally any position where the wafer-facing surface of the platen (including any features on that surface, such as bumps) is not in the contact with the wafer (or in very close proximity thereto as when the wafer is held by a transfer device and the pedestal is in its fully raised position).

As should be apparent, in some situations, the photoresist strip apparatus will process different types of wafers in succession. For example, initially the apparatus may strip bulk (uncrusted) photoresist from wafers. During this operation, rapid, high-temperature processing is desired and, therefore, one or both of the platens in the stations 212 and 213 may be raised and in contact with the wafers being stripped. Later, low resistivity wafers with crusted photoresist may need to be processed. Such wafers should be processed at a lower temperature in the stations 212 and 213. Therefore, the pedestals in one or both of those stations may be lowered. Because those pedestals remain hot from the earlier processing of the bulk (uncrusted) wafers, the use of low emissivity pedestals allows the wafers to remain relatively cool and unaffected by the hot pedestals during crust removal. As indicated, it is often desirable to maintain a pedestal temperature set point during high throughput processing.

In certain embodiments, a system controller 221 is used to control process conditions for various operations of the stripping process described below. For example, the controller 221 may control position of pedestals in each station 211-216, process signals from thermocouples, and perform other functions. The controller 221 typically includes one or more memory devices and one or more processors. The processor may include a CPU or computer, analog, and/or digital input/output connections, stepper motor controller boards, etc.

In certain embodiments, the controller 221 controls all of the activities of the apparatus 200. The controller 221 executes system control software including sets of instructions for controlling the timing of the processing operations, positioning of the pedestals, temperatures, pressure of the chamber, and other process parameters. Other computer programs stored on memory devices associated with the controller 221 may be employed in some embodiments.

In certain embodiments, there will be a user interface associated with controller 221. The user interface may include a display screen, graphical software displays of the apparatus and/or process conditions, and user input devices such as pointing devices, keyboards, touch screens, microphones, etc.

The computer program code for controlling the processing operations can be written in any conventional computer readable programming language: for example, assembly language, C, C++, Pascal, Fortran, or others. Compiled object code or script is executed by the processor to perform the tasks identified in the program.

The controller parameters relate to process conditions such as, for example, timing of the processing steps, flow rates, and temperatures of precursors and process gases, temperature of the substrate (as controlled by e.g., the position of a pedestal with respect to the substrate and/or the energy/power delivered to the pedestal), pressure of the chamber and other parameters of a particular process. These parameters are provided to the user in the form of a recipe, and may be entered utilizing the user interface.

The system software may be designed or configured in many different ways. For example, various chamber component subroutines or control objects may be written to control operation of the chamber components necessary to carry out the inventive deposition processes. Examples of programs or sections of programs for this purpose include substrate timing of the processing steps code, flow rates, and temperatures of precursors and inert gases code, and a code for pressure of the chamber.

The system controller 221 may receive input from the user interface (e.g., an operator entering process parameters, such as a substrate type, temperature requirements, duration of various stripping operations) and/or various sensors (e.g., thermocouples measuring substrate and platen temperatures, radiation measuring devices, sensors registering positions of a substrates and a platen, pressure measuring devices, and others). The system controller 221 may be connected to actuator mechanisms of each station 211-216 inside the processing chamber 201 and configured to control positions (e.g., raised, lowered, intermediate, variable, or any other position) of each platen based on the input provided to the system controller 211. Various control recipes are presented in the description of the stripping process and other parts of this document. For example, the system controller 221 may receive input, which indicates that the next substrate to be processed on the station 212 has low-resistivity and that a HDIS striping method should be used. The system controller 221 may verify certain process conditions from one or more sensors, e.g., the temperature of the next substrate as it is received on a platen of the station 212, a temperature of the platen, substrate resistivity. The system controller 221 may determine that based on all available input the pedestal should be in a lowered position and verify the current position of the pedestal. The system controller 221 may then instruct the actuator of the station 212 to move the pedestal into the lowered position. Further, receiving input and adjusting pedestals' positions may be a dynamic process. The system controller 221 may continuously receive input (e.g., a temperature of a substrate) and readjust pedestals' positions throughout operations in order to control substrates' temperatures with greater precision.

In general, one advantage of the invention is that it allows processing multiple different types of wafers in succession. Examples of the different types of wafers that can be processed in succession include low and high resistivity wafers with uncrusted photoresist, high resistivity wafers with crusted photoresist, and low resistivity wafers with crusted photoresist. By raising and lowering low emissivity pedestals in a manner customized for each type of wafer, the apparatus can accommodate the various different types of wafer processed in succession, thus, improving throughput.

As an alternative to the multi-station apparatus described above, the invention may be implemented as an exposure chamber having a single wafer chamber or a multi-station chamber processing a wafer(s) in a single processing station in batch mode (i.e., non-sequential). In this aspect of the invention, the wafer is loaded onto the platen (pedestal) of the single processing station (whether it is an apparatus having only one processing station or an apparatus having multi-stations running in batch mode). The wafer may be then heated, such as, by providing heat lamps at the wafer backside or by resistively heating the platen. Stripping operations are then performed in a manner similar to the ones described above. However, the wafer remains at the same stations during the entire stripping process. The pedestal of this station may be moved between raised and lowered positions depending on the temperature requirements of each operation, which may vary for different wafer types. In each case, the wafer pedestal will have a low emissivity surface to reduce the impact of radiative heat transfer.

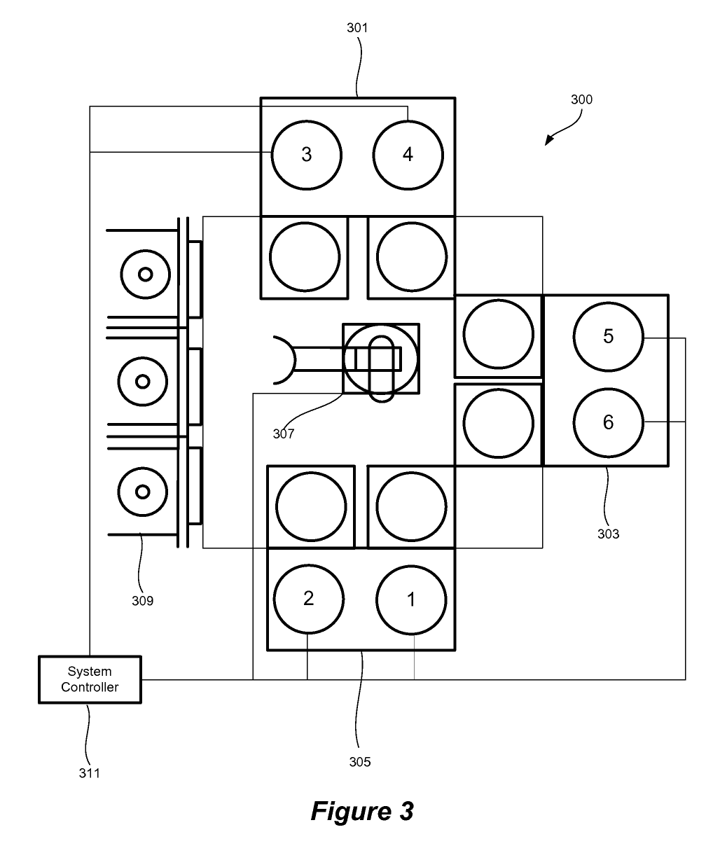

FIG. 3 is a schematic illustration of a multi-chamber stripping apparatus 300 that may be used in accordance with certain stripping processes of this invention. As shown, the apparatus 300 has three separate chambers 301, 303, and 305. Each of the chambers 301-305 has two pedestals. Each chamber 301-305 has its own pressure environment, which is not shared between chambers. Each chamber may have one or more corresponding transfer ports (e.g., load-locks). The apparatus may also have a shared wafer handling robot 307 for transferring wafers between the transfer ports one or more cassettes 309. Each station may be controlled by a system controller 311 that, among other functions, control positions of the low-emissivity pedestal in the corresponding stations.

FIGS. 4A through 4C show an example of a pedestal structure 401 in accordance with certain embodiments. FIGS. 4A and 4C present views of the underside of a platen 403 along with its attached shaft 405. Note that the top side of platen 403, which is shown in FIG. 4B, contacts the substrate while in the raised position in a stripping chamber. The top side also has a low emissivity surface to reduce radiative heating of the substrate, particularly while the pedestal is in the lowered position.

The platen portion of the pedestal is typically sized (and shaped) to accommodate the type of substrate being processed. The size may influence good heat transfer throughout the substrate. In some embodiments, the platen 403 is generally circular and has a diameter of between about 10 inches and 15 inches, or more specifically between about 11 and 14 inches or even more specifically between about 12 and 13 inches. In a specific example, the platen has a diameter of about 12.4 inches. The thickness of the platen (in the direction perpendicular to the substrate-facing surface) may be between about 0.5 inches and 3 inches, or more specifically between about 1 inches and 2 inches. In a specific example, the thickness of the platen is about 1.6 inches.

A heating element 407 is shown embedded in the underside of platen 403. In a specific embodiment, the heating element is a resistive electrical heater, which is implemented as, e.g., a current carrying coil in a metal tube (the visible portion of element 407). In some cases, the tube is an aluminum tube welded into a spiral groove cut in the backside of platen 403. In other embodiments, a heat exchange fluid may be employed to effect the temperature control in the platen 403.

A flange 411 attaches the shaft 405 to the platen 403. A bellows structure 413 attaches to the shaft 405 at a position disposed below the platen 403 and flange 411. The other end of the bellows 413 attaches via an O-ring 415 or other seal mechanism to a lower wall of the stripping chamber. The bellows 413 compresses and decompresses as the pedestal moves between the raised and lowered positions and effectively seals and protects the shaft and associated control lines from attack by plasma during stripping.

A motor or other actuating device (not shown) is coupled to the pedestal 401 to control the position of the platen 403 between the raised and lowered positions. Typically, though not necessarily, the actuating device is coupled to the pedestal 401 via the pedestal shaft 405.

In the depicted embodiment, various control lines 417 for, e.g., providing current to the resistive heating element 407 and thermocouple signals are provided in the shaft 405. These lines are protected in part by the bellows 413.

Typically, the shaft 405 is made from a machined metal and may have a length of between about 5 inches and 10 inches, more typically between about 6 inches and 9 inches, and even more typically about 7 inches and 8 inches. In a specific embodiment, the shaft length is about 7.3 inches. The shaft may be cylindrical or have a different cross-sectional shape that allows engagement with an actuator or other mechanism that drives movement of the pedestal 401 between the raised and lowered positions.

FIG. 4B presents a top view of the platen 403. The top surface 421 of the platen 403 has a low emissivity surface, for example not greater than about 0.5, or more specifically between about 0.01 and 0.3, and even more specifically between about 0.1 and about 0.2. Examples of suitable materials for providing the low emissivity surface include machined and/or plated nickel, gold, rhodium, aluminum, molybdenum, and alloys of these metals. For example, a surface of the pedestal made of an nickel, molybdenum, and aluminum (Ni—Mo—Al) alloy exhibited emissivity as low as 0.01.

In general, emissivity is defined with respect to the relevant operating parameters such as the temperature of the pedestal and the angle at which emissivity is measured. In a radiating body, temperature affects the spectral distribution emitted energy. Thus, the emissivity values provided herein are for the spectral region where emission is the strongest under the conditions of operation. For example, the emissivity values for a wafer-facing surface of platens that are at between about 350° C. and 400° C. generally correspond to wavelengths of between about 2 and 8 micrometers and emissivity angles of about 90°. Further, the provided emissivity values are, in the appropriate context, averages or integrals over the wafer-facing surface of a platen. It should be understood that local emissivity values may differ among various points on the surface. For example, platens may develop scratches and/or local discolorations on their wafer-facing surfaces during operation and therefore have localized emissivity peaks. It should be also understood that wafer-facing surfaces of platens may be periodically refinished to bring their emissivity within the specified ranges.

In some embodiments, the material for the platen 403 is matched with the process conditions such that, over time and while in operation, the condition of the platen surface does degrade to a higher emissivity. However, even in a degraded state, platens generally have emissivity within acceptable range. Further, it may be desirable for some applications to have a surface that is not polished but still has a low emissivity. Such surfaces provide for lesser deterioration of emissivity values during repeated use of platens. For example, some metals, such as aluminum, may have a surface roughness of not greater than about 20 microinches (e.g., about 16 microinches), and in some embodiments between about 5 microinches to 15 microinches to meet the requirements of some applications. In some embodiments, highly polished surfaces may be also be used. Emissivity degradation may be controlled by selecting scratch resistant surfaces, e.g., hard surfaces.

As shown in FIG. 4B, the top surface 421 of the platen 403 has six bumps 423 to support substrates during stripping process. In certain embodiments, these bumps 423 may be sized to keep the substrate and the top surface 421 of the platen 403 separated by between about 0 and 10 mils on average. Of course, other embodiments may employ different numbers of bumps (e.g., 3 to 25) or even no bumps. A minimal gap between substrates and the top surface 421 caused by the bumps does not substantially impact conductive heat transfer between the substrates and the platen 403 unlike substantially larger gap between the two when the pedestal 401 is moved to the lowered position.

Also as shown in FIG. 4B, the platen 403 has grooves 425 to accommodate fingers of the internal wafer transfer robot described above or pegs attached the chamber. The fingers (or the pegs, depending on the implementation) support the substrate when the pedestal 401 is in the lowered position. In the depicted embodiment, the four grooves 425 are show, but the invention is not so limited.

FIGS. 4C, 4D, and 4E show an embodiment in which the flange 411 bolts to the platen 403 via a bolt and retainer assembly 431. This design reduces an observed problem where bolts or screws tend to come loose during temperature fluctuations. For example, bolts or screws tend to come loose when the temperature is raise to at least about 100° C., or in some instances at least about 250° C. Further, vibrations of the platen 403 can cause bolts or screws to come loose. In the design depicted in FIG. 4D, a retainer 433 is placed between a bolt 435 and flange 411.

FIG. 4F illustrates the retainer 433 in accordance with certain embodiments. The retainer 433 has one or more leaves (e.g., leaf 451 and leaf 452), which can also be referred to as wings. The retainer 433 may also have one or more cuts (e.g., cuts 453, 454, and 455) that define the leaves and allow the leaves to be bent. For example, the cuts 453 and 454 may help with bending the leaves 451 and 452 relative to the flat portion 456 of the retainer 433. At the same time, all three cuts 453, 454, and 455 may help with bending the leaves 451 and 452 relative to the plane defined by the leaves 451 and 452. In the bent form, the leaves 451 and 452 engage the top polygonal end of the bolt (element 435 in FIGS. 4D and 4E) when the bolt is tightened. The tightened bolt may orient such that the side of the polygonal end (i.e., one side of the polygon) that is the closest to the leaves 451 and 452 is not approximately parallel to the plane defined by the leaves 451 and 451. In this case, both leaves 451 and 452 of the retainer may be bent relative to each other such that there is very little or no gap between the sides of the bolt and the leaves 451 and 452. In general, the contact between the leaves 451 and 452 and the sides of the bolt are ensured during pedestal assembly and maintenance.

Returning back to FIGS. 4C, 4D, and 4E, the leaves limit the range of movement of the bolt 435 head during subsequent heating. The bolt 435 passes through a sleeve 437 disposed between the flange 411 and the platen 403. Alternative embodiments may employ spring washers and/or a metal string to counter-tighten together in a direction that holds them from unwinding.

Additional or alternative example embodiments of addressing bolt loosening may include selecting materials with appropriate thermal expansion coefficients. The loosening is generally caused when the sleeve 437 and the bolt 435 have different thermal expansion coefficients. For example, if a thermal expansion coefficient of the bolt's material is smaller than that of the sleeve 437, the bolt 435 will expand at a lower rate than the sleeve 437 during heating of the overall pedestal assembly. This will cause significant tensile stresses and deterioration of the bolt's and platen's threaded coupling leading to loosing of the bolt 437. In a somewhat related manner, when the thermal expansion coefficient of the bolt material is higher than that of the sleeve 437, the threaded coupling will relax during the heating of the pedestal assembly. The screw will stay loose and possibly get even looser while the pedestal assembly remains hot.

### Additional Apparatus Parameters

### Plasma Generation

Plasma is used to strip the photoresist. Various compositions may be used. Often an inert gas is used along with an oxidizing agent. The oxidizing agent may include, for example, one or more of the following gases: oxygen, carbon dioxide, carbon monoxide, carbon tetra-fluoride, and inert gas (e.g., argon, helium, and/or nitrogen). In certain embodiments, hydrogen may be included in the plasma. The plasma may be generated by any one of a variety of plasma sources such as a radio frequency source. It may be produced upstream or downstream of the entry point for gas entering the plasma chamber. In a typical case, gas is introduced to the plasma downstream of the plasma source and upstream of a showerhead that directs gas into the reaction chamber.

The plasma source used in accordance with the methods and apparatus of the invention may be any type of plasma source. In a preferred embodiment an RF plasma source is used.

Any known plasma source may be used in accordance with the invention, including a RF, DC, microwave any other known plasma source. In a preferred embodiment, a downstream RF plasma source is used. Typically, the RF plasma power for a 300 mm wafer ranges between about 300 Watts to about 10 Kilowatts. In a preferred embodiment, the RF plasma power is between about 3000 Watts and 6000 Watts.

### Showerhead Assembly

Certain embodiments employ a showerhead assembly. The showerhead assembly may have an applied voltage which impacts the flow of some ions into the reaction chamber. The assembly includes the showerhead itself which may be a plate having holes to direct the plasma and inert gas mixture into the reaction chamber. The showerhead redistributes the active hydrogen from the plasma source over a relatively large area, allowing a smaller plasma source to be used. The number and arrangement of the showerhead holes may be set to optimize strip rate and strip rate uniformity. Fewer holes improve uniformity, but increase recombination of the plasma ions and electrons which results in a lower strip rate. If the plasma source is centrally located over the wafer, the showerhead holes may be smaller and fewer in the center of the showerhead in order to push the active gases toward the outer regions. In a specific embodiment, the showerhead preferably has at least 100 holes.

In embodiments in which there is no showerhead assembly, the plasma enters the process chamber directly.

### Process Chamber

The process chamber may be any suitable reaction chamber. It may be one chamber of a multi-chambered apparatus or it may simply be a single chamber apparatus. As discussed above, the chamber may also include multiple stations where different wafers are processed simultaneously. The process chamber may be the same chamber where the etch takes place or a different chamber than where the etch takes place. Process chamber pressure may range from, e.g., about 300 mTorr to 2 Torr. In certain specific embodiments, the pressure ranges from 0.9 Torr to 1.1 Torr.

### Work Piece

In preferred embodiments, the work piece used in accordance with the methods and apparatus of the invention is a semiconductor wafer. Any size wafer may be used. Most modern wafer fabrication facilities use either 200 mm or 300 mm wafers. Process conditions may vary depending upon the wafer size. In particularly preferred embodiments, the work piece comprises a single or dual Damascene device.

In embodiments of the invention, it is desired to keep the work piece at a particular temperature during the application of plasmas to its surface. In certain embodiments, the wafer temperatures can range between about 220 degrees and about 300 degrees Celsius.

In some embodiments, the surface of the work piece comprises low-k dielectric materials or other materials employed in Back End of Line (BEOL) processing. In some embodiments, the surface of the work piece includes silicon (single crystalline and/or polysilicon) as is typical in Front End of Line (FEOL) processing.

### Positioning the Pedestal

In removing the material from a work piece in accordance with the invention, the platen in the processing station may reside in a lowered position for forming the gap and preventing the substrate from contacting the platen. The gap that prevents the substrate from contacting the platen. Generally, any predetermined gap can be used that can provide acceptable heat transfer.

In certain embodiments, the gap may change during an operation to control substrate temperature in a closed loop fashion. For example, there may be a predetermined initial gap, which is a gap at which the closed loop temperature control begins. The predetermined initial gap is typically at or close to the minimum gap necessary to maintain wafer integrity, i.e., to keep the wafer from becoming distorted, from contamination by the pedestal, etc. In some embodiments, the predetermined initial gap is the wafer distortion threshold gap, the minimum gap at which the wafer does not experience thermal distortion. In an atmospheric nitrogen environment, this threshold is about 0.05 inches for a 400° C. pedestal. In general, the predetermined initial gap is not smaller than this threshold. The temperature may be then maintained by varying the wafer-pedestal gap with or without adjusting the pedestal temperature. If not already there, the temperature is brought to the desired value in this operation prior to maintaining the desired temperature. In certain embodiments, logic device controls instruct a servo motor to set a prescribed motion using a wafer temperature signal as input. The device may use, e.g., PID algorithms for stable and accurate control.

Signals from thermometry equipment are sent to a controller, which then sends signals to a motor to move the pedestal closer to or further from the wafer as required to obtain and maintain the desired final temperature. The range of allowable gaps is generally limited by the maximum allowable distance the equipment can achieve (e.g., the pedestal down position) and a minimum gap that ensures wafer integrity. As indicated, in some embodiments, the latter is the wafer distortion threshold gap. In other embodiments, the wafer may be provided to the preheat station at the predetermined initial gap, at which point the feedback control begins. This often means that wafer will stay at this small gap until it nears the desired final temperature.

The initial approach parameters typically include a set velocity or set acceleration and the predetermined initial gap. The feedback control stage parameters include a max velocity, a max acceleration, and a minimum gap. The predetermined initial gap may be experimentally or computationally determined for each type of wafer/desired temperature/pedestal temperature. In addition to constraining the predetermined initial gap to distances above that of the thermal distortion threshold gap, the gap should be big enough so that any variation in wafer-pedestal gap across the wafer (due to, for example, variations in the pedestal surface) is insignificant compared to the gap. In certain embodiments, this initial gap may also be set to be the minimum gap during the feedback control stage. In certain embodiments the minimum gap used during the feedback control stage differs from the predetermined initial gap. For example, because the thermal distortion threshold gap is dependent on the temperature differential between the wafer and the pedestal, becoming smaller as the temperature differential becomes smaller, this minimum gap may be smaller than the predetermined initial gap.

The initial approach stage described above is just one example of a stage prior to a feedback control stage. For example, the initial approach stage may be broken up into two or more stages, having different gaps, approach velocities, etc. As mentioned, in certain embodiments, there may be no initial approach, with the feedback control stage beginning immediately after introducing the wafer to the station.

Each station of the apparatus may include a thermocouple and controller. The thermocouple may be positioned near to the peripheral edge of the wafer to sense the temperature of the wafer. Output voltage from the thermocouple is sent to the controller, e.g., via a wire or other connection. The controller then sends a signal to the motor in response to the signals received from the thermocouple.

Temperature measurement may be performed by any suitable device including a thermocouple, a pyrometer, an emissometer that measures the infrared radiation coming off the wafer, etc. Generally, a no-contact temperature measuring device is used to avoid tainting or damaging the wafer. If a contact device is used, it may be contact the underside or edge of the wafer rather than the topside. In a particular embodiment, a blackbody may be placed next to the wafer, with a thermocouple in the blackbody to monitor temperature. In certain embodiments, one or more thermocouples are suspended or supported near the wafer. Multiple thermocouples placed at different points may used to supply additional temperature information. The thermocouple outputs a direct voltage that is an indicator of temperature.

As indicated, the temperature sensing device sends wafer temperature information to a controller, generally in the form of an output voltage. The controller analyzes the data and in turn sends instructions to a linear motor to modulate the wafer-pedestal gap and keep the temperature at the desired level. In general, accurate feedback control with small overshoot is necessary. In certain embodiments, the controller is programmed with Proportional Integral Derivative (PID) algorithms for stable and accurate control. In certain embodiments, the motor used to move the pedestal and/or wafer support is a servo controlled linear actuator motor, which receives instructions for a prescribed motion based on input from the thermometry equipment. The motor may have embedded logic circuitry to support the PID closed loop algorithms for gap variance.

As indicated above, the wafer-pedestal gap may be modulated by moving the pedestal or a wafer support holding the wafer in relation to each other. In certain embodiments, both may be capable of moving in response to modulate the gap. Any type of pedestal may be used including convex, concave, or flat pedestals in various shapes and sizes. The pedestal typically has a heating element and has a thermocouple to control its temperature. In certain embodiments, the temperature is constant and the rate at which heat transfers to the wafer is controlled primarily by modulating the wafer-pedestal gap. However, in some embodiments, the pedestal heater power may also be varied.

The closed loop temperature control using gap variance to control the temperature as discussed above provides easier to implement and low cost alternatives to other closed loop wafer control systems that would use variance in light source, plasma intensity, or power supplied to the heater.

### Multi-Station Processing Chambers

As indicated, some of the processing stations may be adjustable to allow separation between the substrate and the platen for controlling the temperature of the substrate. In these processing stations, the platens may each reside in a lowered position for minimizing heat transfer from the platen to the substrate or in a raised position to allow conduction from the pedestal to the substrate.

In a typical embodiment, the substrate is preheated to a temperature in a first station of the plurality of stations. The substrate is then transferred to a second station, where the substrate is positioned over the second station platen to optionally form a gap that prevents the substrate from contacting the platen.

Once the substrate is processed in the second station, the method may further include transferring the substrate to a third station. The substrate is positioned over the third station platen to optionally form another gap for preventing the substrate from now contacting the third station platen. The substrate may then be sequentially transferred and processing in any remaining processing stations within the reaction chamber.

The invention may be implemented on a Gamma® tool of Novellus Systems, Inc. that has been modified in accordance with the invention. Specifically, one or more of the pedestals in the Gamma® may be modified to have a low emissivity surface as described herein. The Novellus Gamma® tool supports the sequential processing of up to six wafers in a common process chamber and is generally used for the purposes of resist strip, clean and dielectric and silicon etch applications. However, it should be appreciated that the invention is not limited to the Novellus Gamma platform, but can be applied to other strip or etch process tool platforms.

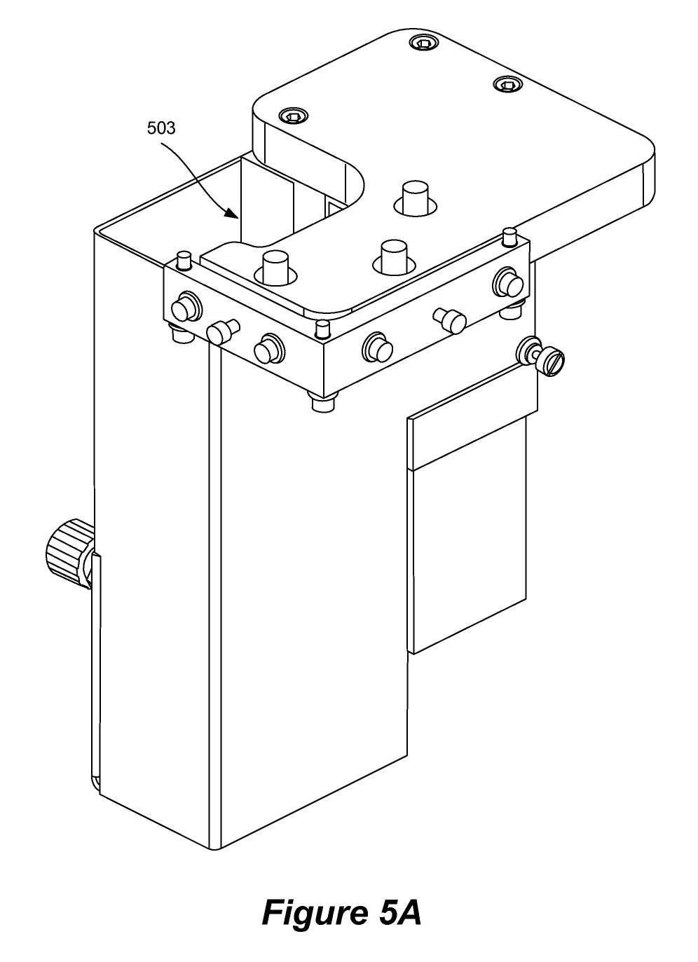

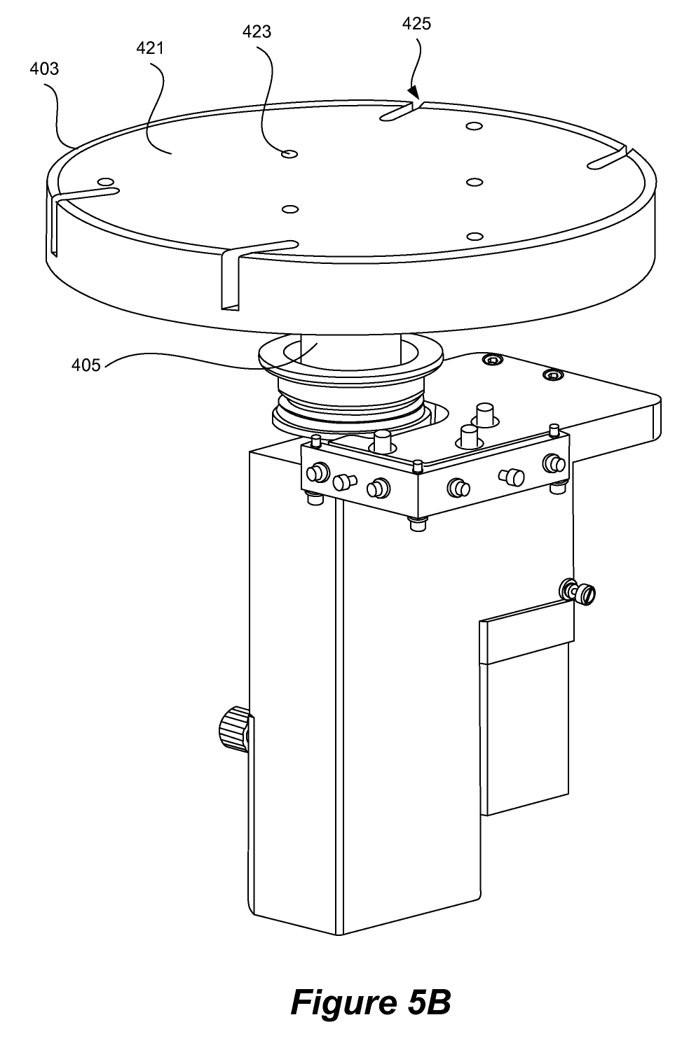

FIG. 5A is a perspective drawing of a motorized lift mechanism for coupling to a pedestal shaft and thereby allowing the pedestal to be raised and lowered between the raised and lowered positions in a photoresist strip chamber. The pedestal shaft fits in a slot indicated by reference number 503. FIG. 5B shows an assembly of the lift mechanism and the pedestal together. When installed, the pedestal and the lift mechanism straddle a bottom wall of the process chamber.

### Processing Different Types of Wafers

As stated above, different types of substrates may be processed in succession in the same stripping chamber. The types may include low and high resistivity wafers with uncrusted photoresist, high resistivity wafers with crusted photoresist, and low resistivity wafers with crusted photoresist, among others. A combination of a platen surface with low emissivity and a controllable position with respect to the substrates position allows processing different substrate types without changing other processing parameters, such as the platen's temperature. This results in higher process throughputs and greater flexibility for a given process apparatus.

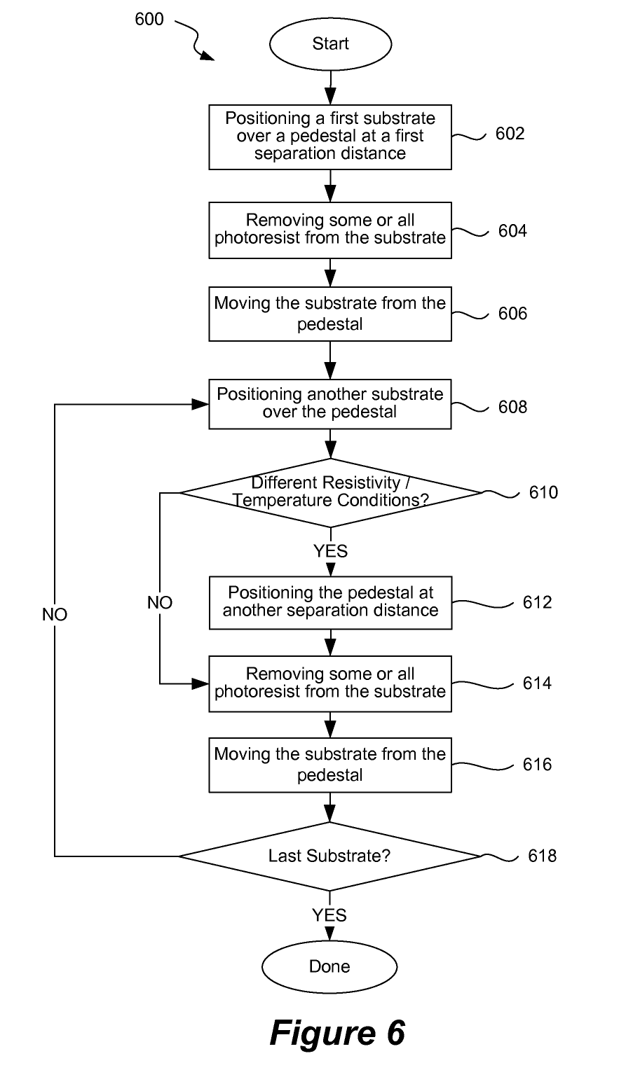

FIG. 6 illustrates an example process flowchart for a method of stripping photoresist from a plurality of substrates having varying resistivity and/or photoresist conditions. The process may start with positioning a first substrate over a pedestal that is in the first position (operation 602). Generally, any pedestal in a multi-station chamber may be described by this process. More specifically, pedestals where different substrate temperatures are required for processing different substrate types are considered. For example, pedestals of the stations 212 and 213 illustrated in FIG. 2 may need to change their positions when switching between bulk stripping and HDIS stripping. Bulk stripping requires higher temperatures during early stripping stages (stations 212 and 213), and the first position of the pedestal during the operation 602 would correspond to the raised position. On the contrary, HDIS stripping requires lower temperatures during early stripping stages (e.g., to remove crust) and the first position of the pedestal during the operation 602 would correspond to the lowered position. The first position may be selected externally (e.g., based on operator's input), internally (e.g., based on sensors' responses), a combination of the two.

The process may then proceed with removing some or all photoresist from the first substrate (operation 604), while the pedestal is retained in the first position. Alternatively, the pedestal may be adjusted during the operation 604 to achieve more precise temperature control. For example, a thermocouple may be used to monitor the temperature of the substrate. Pedestal position is adjusted according signals received from the thermocouple.

In the next operations, the first substrate is moved to from the pedestal (operation 606), and a new substrate is positioned over the pedestal (operation 608). The method continues with determining whether the new substrate has a different resistivity that the previously processed substrate or needs to be at a different temperature during processing (operation 610). Other process parameters and substrate characteristics may also be considered during this operation. For example, the operation 610 may determine that the pedestal has not be lowered or raised into another position, in which case the process proceeds to operation 612 in which the pedestal is repositioned and only then to removal of photoresist operation 614. Alternatively, the operation 610 may indicate that no pedestal repositioning is required (e.g., the new wafer has the same type as the previously processed wafer). In this case, the process proceeds directly to the operation 614.

During the operation 614, some or all photoresist is removed from the substrate. Similar to the operation 604, the pedestal may remain in the same position during the entire operation 614 or change its position to achieve better temperature control. Other process conditions (e.g., plasma composition, plasma energy) in the operation 614 may also be adjusted or controlled depending on the type of the processed substrate.

Once, the new substrate is processed, it is removed from the pedestal in operation 616, and the process inquired whether there is another wafer that needs processing at this pedestal (operation 618). If there is another wafer, operations 608-618 are repeated.

In some embodiments, the stripping apparatus of this invention may also used in stripping processes associated with a PLAD process (Plasma Assisted Doping), which provides very high concentrations (e.g., 1×10¹⁶ cm⁻² or more) of dopant, typically boron, arsenic, or phosphorous. Higher concentrations make it more difficult to remove crust because dopants that are trapped in the crust are generally less volatile than the oxidized photoresist material. Sometimes, a fluorine-containing compound is added to the plasma to enhance removal process. In other examples, the substrate is exposed to the first plasma formed from oxygen and a forming gas. The forming gas may include hydrogen (e.g., between about 0.5 and 10 molar percent, or more specifically between about 4 and 6 molar percent, or even more specifically about 5 molar percent). This method may also include a step of forming a thin oxide on the substrate using the oxygen and forming gas in the first plasma. The oxide may be sufficiently thick to prevent or, at least, minimize loss of silicon when the substrate is exposed to fluorine radicals. For example, the oxide may be between about 0 and 5 nanometers, or more specifically between about 0 and about 2 nanometers, thick.

The forming gas in the first plasma serves as a reducing agent to reduce the crust of the photoresist. In particular, the hydrogen quite effectively reduces boron oxide to more volatile species via the mechanism:

B₂O₃+H⁺→B_{X}H_{Y}+O_{Z}.

These volatile species can be more easily removed from the semiconductor substrate than the un-reduced crust. In an exemplary embodiment of the invention, the first plasma comprises an oxygen-to-forming gas ratio in the range of 0:1 to 1:0. In a preferred embodiment of the invention, the first plasma comprises an oxygen-to-forming gas ratio in the range of about 19:1 to about 1:19. In a more preferred embodiment, the first plasma comprises an oxygen-to-forming gas ratio of about 4:1.

After the semiconductor substrate has been exposed to the first plasma for a time sufficient to remove a portion of the photoresist and permit an oxide layer to form on the substrate, the substrate then is subjected to a second plasma. In an exemplary embodiment of the invention, the second plasma is formed from oxygen, a forming gas or an inert dilutant, such as, for example, nitrogen or helium, and a fluorine-comprising gas that serves as a source of fluorine radicals. The fluorine-comprising gas can be nitrogen trifluoride (NF₃), sulfur hexafluoride (SF₆), hexafluoroethane (C₂F₆), tetrafluoromethane (CF₄), trifluoromethane (CHF₃), difluoromethane (CH₂F₂), octofluoropropane (C₃F₈), octofluorocyclobutane (C₄F₈), octofluoro[1-]butane (C₄F₈), octofluoro[2-]butane (C₄F₈), octofluoroisobutylene (C₄F₈), fluorine (F₂), and the like. In an exemplary embodiment of the invention, the second plasma is formed from oxygen, forming gas or nitrogen, and CF₄. In certain embodiments, the second plasma is formed from oxygen present in the range of about 10% to about 100%, forming gas or nitrogen present in the range of about 0% to about 50%, and CF₄ present in the range of about 0% to about 20%. In more specific embodiments, the second plasma is formed from oxygen, forming gas or nitrogen, and CF₄ in a ratio of oxygen: forming gas or nitrogen:CF₄ of about 16:2:0.05. Forming gas may allow for more accurate control of silicon loss because the hydrogen bonds with fluorine radicals. The second plasma removes the photoresist residue and, at a much slower rate, the thin oxide layer while minimizing the silicon consumed during the second plasma process.

In an exemplary embodiment of the invention, the semiconductor substrate is maintained at or heated to a temperature in the range of about 16° C. (i.e., room temperature) to about 300° C. during exposure to the second plasma. The time during which the semiconductor substrate is exposed to the second plasma is a function of the thickness of the photoresist residue after the first plasma process. The semiconductor also is maintained at a pressure in the range of about 1 mTorr to about 1 Atm, preferably about 0.1 Torr to about 10 Torr. It will be understood that exposure to the first plasma and exposure to the second plasma can be performed as two discrete steps, for example, with a purge step performed therebetween, or can be performed as one continuous plasma flow step with the composition of the continuous plasma flow changing from the composition of the first plasma to the composition of the second plasma.

### CONCLUSION

Although the foregoing invention has been described in some detail for purposes of clarity of understanding, it will be apparent that certain changes and modifications may be practiced within the scope of the appended claims. It should be noted that there are many alternative ways of implementing the processes, systems, and apparatuses of the present invention. Accordingly, the present embodiments are to be considered as illustrative and not restrictive, and the invention is not to be limited to the details given herein.

What is claimed is:

1. A pedestal for supporting a substrate in an apparatus for stripping photoresist from a substrate, the pedestal comprising:
(a) a platen having a substrate-facing surface having an emissivity of not greater than about 0.3,
(b) a heating element embedded in the platen; and
(c) a shaft coupled to the platen and having a feature for engaging with an actuator and allowing the pedestal to be moved between a lowered and a raised position within the apparatus.

2. The pedestal of claim 1, wherein the substrate-surface of the platen has one or more bumps for supporting the substrate.

3. The pedestal of claim 2, wherein the bumps are between about 0 and 0.010 inches in height.

4. The pedestal of claim 1, wherein the substrate-facing surface of the platen has an emissivity of about 0.1 to 0.2.

5. The pedestal of claim 1, wherein the heating element comprises a resistive heating element.

6. The pedestal of claim 1, wherein the shaft houses one or more control lines.

7. The pedestal of claim 1, wherein the platen is made from aluminum and has a diameter of between about 12 to 13 inches, and wherein the shaft has length of about 6 to 9 inches.

8. An apparatus for stripping photoresist from substrates, the apparatus comprising:
(a) a chamber containing a connection for connecting to a vacuum line;
(b) a plasma source for producing a plasma for stripping photoresist from the substrates;
(c) a pedestal for heating the substrates during said stripping, the pedestal comprising:
(i) a platen having a substrate-facing surface having an emissivity of not greater than about 0.3, and
(ii) a shaft coupled to the platen and engaged with a wall of chamber; and
(d) an actuator for moving the platen between raised and lowered positions in the chamber.

9. The apparatus of claim 8, further comprising a showerhead for directing the plasma and inert gas into the process chamber.

10. The apparatus of claim 8, wherein the plasma source comprises an RF coil for generating plasma.

11. The apparatus of claim 8, wherein the substrate comprises a dielectric layer on a partially fabricated integrated circuit.

12. The apparatus of claim 8, further comprising a substrate supporting mechanism for supporting the substrate when the platen in the lowered position.

13. The apparatus of claim 8, wherein a gap between the substrate and the substrate facing surface is on average between about 0.001 inches and 3 inches when the platen is in lowered position.

14. The apparatus of claim 8, wherein the substrate is a 300 mm semiconductor wafer.

15. The apparatus of claim 8, wherein during stripping the temperature of the substrate ranges between about 100 degrees and about 300 degrees Celsius.

16. The apparatus of claim 8, wherein during stripping the pressure in the process chamber ranges between about 300 mTorr and about 2 Torr.

17. The apparatus of claim 8, further comprising a flange around the shaft and bolted to the platen by a bolt and a retainer having a leaf engaging a polygonal face of the bolt to limit movement of the bolt.

18. A method of stripping photoresist from a plurality of substrates having varying resistivity and/or photoresist conditions, the method comprising:
(a) positioning a first substrate over a pedestal in a first position in a stripping chamber, wherein the pedestal has a substrate-surface facing and said surface has an emissivity of about 0 to 0.3;
(b) removing some or all photoresist from the first substrate while the pedestal is in the first position;
(c) moving the first substrate away from the pedestal;
(d) positioning a second substrate over the pedestal in the stripping chamber, wherein the pedestal is in a second position; and
(e) removing some or all photoresist from the second substrate while in the pedestal is in the second position.

19. The method of claim 18, wherein the first substrate and second substrate have different photoresist and/or resistivity conditions.

20. The method of claim 18, wherein the distance between the substrate facing surface of the pedestal in the first position and the first substrate is less than the distance between the substrate-facing surface pedestal in the second position and the second substrate.
